(19) United States
(12) Patent Application Publication
(10) Pub. No.: US 2011/0048473 A1
(43) Pub. Date: Mar. 3, 2011

(54) HOLDER FOR A CLEANING LANCE AND VEHICLE WASHING SYSTEM

(75) Inventor: Robert AUER, Stadtbergen (DE)

(73) Assignee: WashTec Holding GmbH, Augsburg (DE)

(21) Appl. No.: 12/868,114

(22) Filed: Aug. 25, 2010

(30) Foreign Application Priority Data
Aug. 28, 2009 (DE) 20 2009 011 706.5

(51) Int. Cl. B08B 3/00; B01D 35/02

(52) U.S. Cl. 134/111; 210/153; 134/110

(57) ABSTRACT

The invention relates to a holder (1) for a cleaning lance (19) with an insertion compartment (3) for accommodating at least a front end of the cleaning lance (19), wherein the insertion compartment (3) runs from an insertion opening (2) for the cleaning lance (19) at an angle downward to a drain end (4) with a fluid drain (5), and relates as well to a vehicle washing facility (18) with a cleaning lance (19) and a holder (1) for the cleaning lance (19) The problem of creating a holder for a cleaning lance and a vehicle washing facility that can securely prevent clogging of the holder's fluid drain and any downstream fluid reprocessing system, are easy to clean and operate reliably is solved by the holder according to the invention in that the holder (1) has a screen insert (6) that can be inserted into the insertion compartment (3). A vehicle washing facility according to the invention has such a holder (1).

### CROSS REFERENCE TO RELATED APPLICATIONS

This application claims priority under 35 U.S.C. §119 to German Patent Application No. 20 2009 011 706.5 filed Aug. 28, 2009, the entire contents of which are incorporated herein by reference.

### FIELD OF THE INVENTION

The invention relates to a holder for cleaning lance as well as to a vehicle washing system.

### BACKGROUND OF THE INVENTION

A holder for a cleaning lance and a vehicle washing system are known from DE 4226712 A1. In the system for manual cleaning of motor vehicles shown there, a holder for accommodating washing lances is provided on a pillar. The holder is provided either as a cylindrical sleeve or a cuboid-shaped hollow body and is mounted slanting downwards on the support pillar. Cleaning fluid dripping out of the holder can be diverted by a short pipe section to a drain in the interior of the support pillar. Wash water still flowing out of the washing lance can easily be drained in this manner.

Such holders for washing lances, especially the sleeves or hollow bodies, are misused by many users as waste baskets. Thereby the liquid outlet at the lower end of the sleeve becomes clogged, so that the fluid running out of the cleaning lance accumulates until it overflows out of the top of the sleeve. Moreover, the washing lance nozzle becomes clogged or the brushes on the washing lance become contaminated by the waste, especially cigarette butts, accumulated in the sleeve. In addition, icing up of the washing lance or brush in vehicle washing facilities in colder areas with frost and ice is prevented by having a small amount of fluid continuously flowing through the washing lance. This continuously flowing fluid must be able to run out of the end of the sleeve. If that is not possible, the sleeve rapidly fills up with fluid, so that in case of temperatures below the freezing point, the fluid gradually freezes and a solid block of ice forms in the sleeve. The washing lance can then no longer be used.

To avoid clogging by refuse, the sleeve for known holders is formed without a bottom at its lower end, so that discarded refuse falls back out at the lower end. But even in this case, larger objects, such as cigarette packs can be put in the sleeve and become caught there, so that objects thrown in later continue to clog up the sleeve.

If fluid is drained, as described in DE 4226712 A1, via a pipe section into the interior of the support pillar, the above solution is not possible. Such a fluid drain exists in vehicle washing facilities for which a small amount of fluid runs through the washing lance to protect against freezing, and also in those for which a closed fluid circuit for recovery of the fluid is required for environmental protection reasons. Clogging of the fluid drain or of a fluid reprocessing system connected to it would likewise lead to a shutdown of the facility and considerable expense for cleaning or repairing the fluid reprocessing system and its supply lines.

U.S. Pat. No. 4,902,153 discloses another holder for a cleaning brush for vehicles. The insertion compartment there is closed at the bottom; a fluid contained in it can therefore not drain downwards. Instead, the insertion compartment is filled with water sufficiently that the inserted brush part of the cleaning lance is always covered by water. Thereby the bristles of the brush are supposed to be kept soft and clean, and freezing in the winter is to be prevented. A screen insert in which the water would always drain off out of the insertion compartment would be virtually nonsensical here.

### SUMMARY OF THE INVENTION

It is therefore the problem of the invention to create a holder for a cleaning lance and a vehicle washing facility as mentioned above that can overcome the above-mentioned disadvantages and securely prevent clogging of the holder's fluid drain and any downstream fluid reprocessing system, are easy to clean and operate reliably.

This problem is solved by a holder for a cleaning lance with the characteristics of Claim 1 and a vehicle washing facility with the characteristics of Claim 13. Advantageous configurations and expedient refinements of the invention are specified in the subordinate claims.

The holder according to the invention is characterized in that it has a screen insert that can be pushed into the insertion compartment. The screen insert can be easily removed manually from the insertion compartment, the refuse situated therein can be removed and the screen insert can then be pushed back into the insertion compartment.

In an advantageous embodiment of the invention, a fluid-permeable filter material can be arranged in the screen insert, and can be configured to be removable in a preferred refinement. For this purpose, retaining means for holding the filter material in the screen insert can advantageously be provided in the screen insert. In this way, the screen insert can be adapted to different conditions of the vehicle washing facility. For example, a filter material with larger pores can be used in the winter to securely prevent the filter material from being frozen shut. In this manner a filter material that has become contaminated and clogged due to long use can be easily replaced.

In a user-friendly embodiment, the screen insert can have a handle that can be grasped from the insertion opening and preferably extends nearly up to the insertion opening. Thereby the operating personnel need not reach far into the insertion opening and the insertion compartment, which is particularly unpleasant in case of large-sized refuse.

In a configuration advantageous for fast exchange of the screen insert, an outer contour of the screen insert perpendicular to the insertion direction and an inner contour of the insertion compartment perpendicular to the insertion direction are matched to one another in such a manner that the screen insert can easily be pushed into or pulled out of the insertion compartment in the insertion direction. Guidance means running in the insertion direction, such as guide rails on the insertion compartment and corresponding guide grooves on the screen insert, or conversely, can advantageously be provided in the insertion compartment and on the screen insert.

In order to keep the screen insert in a prescribed position in the insertion compartment, and prevent slippage of the screen insert, a retaining means is provided in one advantageous configuration that prevents slippage of the screen insert through the insertion compartment. In an advantageous construction, the retaining means can be a grid closing off the drain end of the insertion compartment. Alternatively or additionally, the retaining means can be one or more stops protruding into the interior of the insertion compartment, against which the corresponding counter-stops of the screen insert strike.

A vehicle washing facility according to the invention has a holder according to the invention. In an advantageous configuration, the vehicle washing facility can be constructed in such a manner that the fluid drain of the holder is connected to a fluid reprocessing system of the vehicle washing facility. In this manner, fluid exiting the holder can be directly supplied to the fluid reprocessing system without the fluid reprocessing system becoming clogged or contaminated by refuse or small particles. The holder can advantageously be part of a closed fluid circuit of the vehicle washing facility, so that a secure and reliable and simultaneously environmentally friendly operation of the vehicle washing facility can be assured, despite the refuse often thrown into the holder.

### BRIEF DESCRIPTION OF THE DRAWINGS

Additional special aspects and advantages of the invention follow from the description below of a preferred embodiment with reference to the accompanying drawings. Therein:

FIG. 1 shows a schematic three-dimensional view of a part of a vehicle washing facility according to the invention with a holder according to the invention for a cleaning lance 19;

FIG. 2 shows a section through the vehicle washing facility shown in FIG. 1;

FIG. 3 shows a schematic three-dimensional view of a screen insert according to the invention;

FIG. 4 shows a cross section through the screen insert from FIG. 3 in a cross-section plane Q;

FIG. 5 shows a schematic representation of the vehicle washing facility according to the invention.

### DETAILED DESCRIPTION OF THE INVENTION

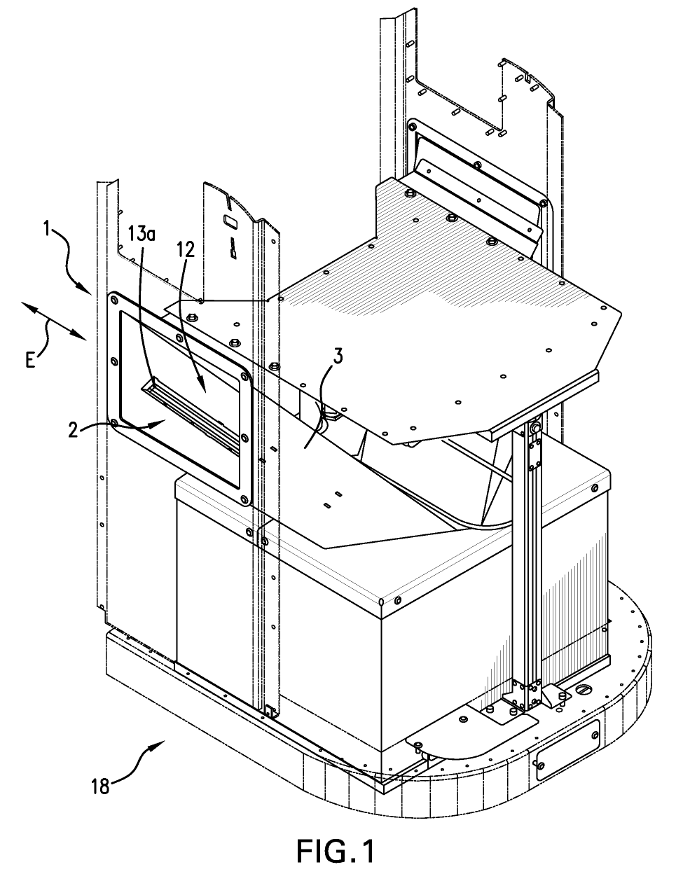

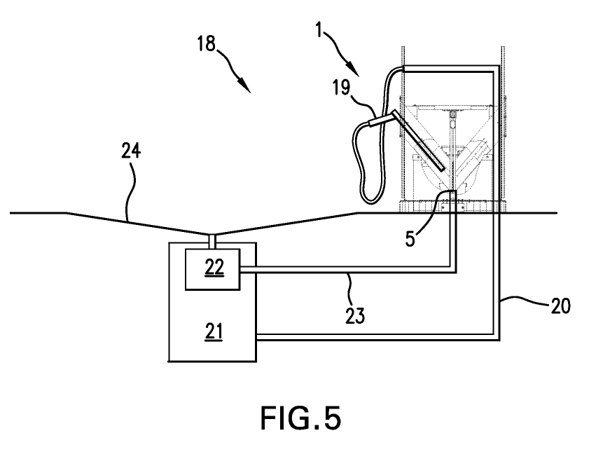

A holder 1 according to the invention as shown in FIG. 1 for a cleaning lance 19 of a vehicle washing facility 18 according to the invention as shown in FIG. 5, has an insertion compartment 3 furnished with an insertion opening 2. The insertion compartment 3 serves to accommodate at least the front end of the cleaning lance 19 with the cleaning nozzle from which cleaning fluid or water can be applied to a vehicle to be cleaned.

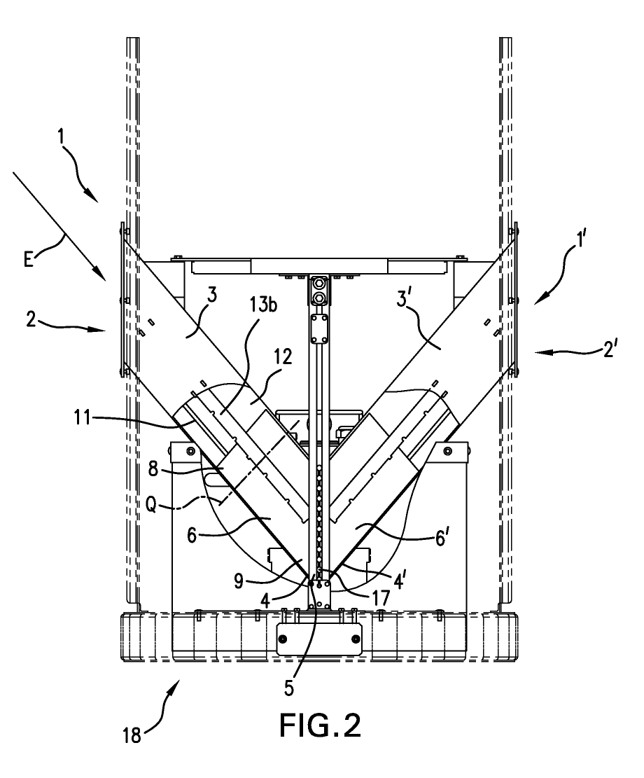

The insertion compartment 3 runs from the insertion opening 2 at an angle downwards to a drain end 4, at which a fluid drain 5 indicated in FIGS. 2 and 5 is provided. The fluid drain 5 directs fluid flowing from the cleaning lance 19 to a fluid reprocessing system 22 shown in FIG. 5.

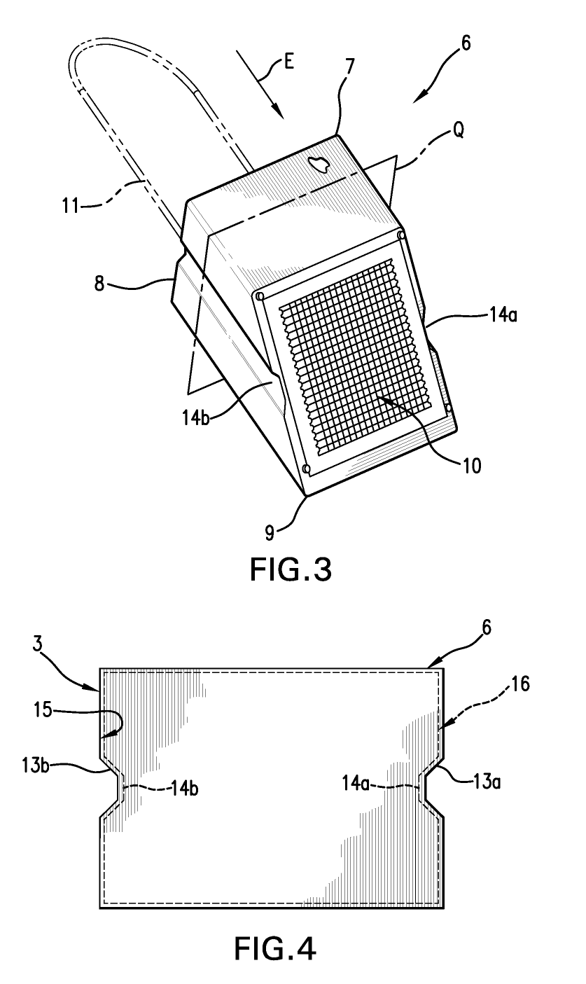

A screen insert 6 that is shown in detail in FIG. 3 can be pushed into the insertion compartment 3 from the insertion opening 2. The screen insert 6 comprises a hollow body 7, substantially rectangular in cross section, as shown in the cross section in FIG. 4 through a cross-section plane Q in FIG. 3.

An insertion end 8 of the screen insert 6, the upper end in FIG. 2, is open to the top, so that the cleaning lance 19 can be pushed up to a lower filter end 9 of the screen insert 6 with the screen insert 6 pushed into the insertion compartment 3. The hollow body 7 is slanted at the filter end 9, with the opening there being closed off by a filter material 10 produced from a wire fabric. In this way, fluid can pass from the cleaning lance 19 through the filter material 10, while solid bodies thrown into the insertion compartment 3 are held back. The filter material 10 is fixedly arranged on the hollow body 7.

In an alternative embodiment, not shown, the filter material can advantageously be removable from the screen insert 6. In another embodiment, not shown, a relatively coarse-mesh filter material can advantageously be fixedly arranged at the filter and 9. An additional filter material such as a fine-mesh filter fabric or a nonwoven fiber filter can be inserted from the insertion opening 8 into the screen insert 6 and held in the screen insert 6 by the coarse-mesh filter material serving as a retaining means.

In order to facilitate removal of refuse collected in the screen insert 6 for the personnel, a handle 11 that consists of a robust round wire bent in the shape of an open, U-shaped loop is provided at the insertion end 8. The handle 11 reaches from the insertion end 8 in the direction of the insertion opening 2 nearly up to the insertion opening 2, and can thus be easily gripped from the insertion opening 2 even if the screen insert 6 is positioned at the very bottom in the insertion compartment 3.

In order to simplify the insertion and removal of the screen insert 6, two guide rails 13a and 13b projecting into an interior 12 of the insertion compartment 3 are provided on the insertion compartment 3. The screen insert 6 has corresponding guide grooves 14a and 14b running in the insertion direction E. The guide rails 13a, 13b, together with the guide grooves 14a, 14b, form a guidance means for the screen insert 6, i.e., assure the secure guidance of the screen insert 6 in the insertion compartment 3. In place of the embodiment shown, guide rails can be arranged on the screen insert 6 and corresponding guide grooves can be arranged on the insertion compartment 3.

As is seen from the cross section through insertion compartment 3 and screen insert 6 in FIG. 4, an inside contour 15 of the insertion compartment 3, as well as an outside contour 16 of the screen insert 6, are matched to one another in such a manner that the screen insert 6 is easily and well guided in the insertion compartment 3. In principle, this matching is sufficient for the guidance of the screen insert 6 in the insertion compartment 3, but the guide rails 13a, 13b and the guide grooves 14a, 14b can be provided as additional guidance assistance, as in the present case.

In the embodiment shown, slippage of the screen insert 6 through the insertion compartment 3 is prevented by the fact that two identically constructed insertion compartments 3, 3′ are arranged axially symmetrically relative to one another. The drain ends 4, 4′ of the insertion compartments 3, 3′ adjoin one another, so that two inserted screen inserts 6, 6′ contact one another at the abutment site of the insertion compartments 3, 3′. In order to prevent the screen inserts 6, 6′ inserted into the holders 1, 1′ from catching on one another, a grid 17 is arranged at the drain end 4 of the insertion compartment 3. The screen inserts 6, 6′ are securely held at the drain ends 4, 4′ of the insertion compartments 3, 3′ by the grid 17, although fluid can still run out through the grid 17 to the fluid drain 5. The grid 17 can advantageously be used even with only one insertion compartment 3 in order to prevent slippage of the screen insert 6.

In the vehicle washing facility 18 shown in FIG. 5, the cleaning lance 19 is inserted into the insertion compartment 3 of the holder 1. The cleaning lance 19 is supplied with water or cleaning fluid from a fluid supply system 21 via a fluid supply line 20. The vehicle washing facility 18 is set up such that there is always a certain amount of fluid flowing through the cleaning nozzle of the cleaning lance 19, in order to prevent the cleaning nozzle from icing up. The liquid supply system 21 has a liquid reprocessing system 22 which reprocesses fluid flowing back via a return line 23 from the fluid drain 5 of the holder 1, as well as fluid draining from a washing area 24 of the vehicle washing facility 18, for reuse by the fluid supply system 21. By using the holder 1 of the invention with the screen insert 6, it is assured that the vehicle washing facility 18 can be operated reliably and safely even in case of considerable contamination of the insertion compartment 6.

1. Holder for a cleaning lance with an insertion compartment for accommodating at least a front end of the cleaning lance, wherein the insertion compartment runs from an insertion opening for the cleaning lance at an angle downward to a drain end with a fluid drain, wherein the holder has a screen insert that can be inserted into the insertion compartment.

2. Holder according to claim 1, wherein a fluid-permeable filter material is arranged on the screen insert.

3. Holder according to claim 2, wherein the filter material can be removed from the screen insert and the screen insert has retaining means for holding the filter material in the screen insert.

4. Holder according to claim 2, wherein the screen insert has a hollow body with an insertion end open towards the insertion opening, and a filter end closed off by the filter material.

5. Holder according to claim 1, wherein the screen insert has a handle that can be grasped from the insertion opening.

6. Holder according to claim 1, wherein an outer contour of the screen insert running perpendicular to an insertion direction and an inner contour of the insertion compartment perpendicular to the insertion direction are matched to one another for guiding the screen insert in the insertion compartment.

7. Holder according to claim 1, wherein guidance means running in the insertion direction are provided in the insertion compartment and on the screen insert.

8. Holder according to claim 7, wherein the guidance means have guide rails protruding into an interior space of the insertion compartment and matching guide grooves on the screen insert.

9. Holder according to claim 1, wherein a retaining means is provided for retaining the screen insert in a prescribed position in the insertion compartment.

10. Holder according to claim 9, wherein the retaining means is a grid closing off the drain end of the insertion compartment.

11. Holder according to claim 9, wherein the retaining means comprises one or more stops protruding into the interior of the insertion compartment, against which the corresponding counter-stops of the screen insert strike.

12. Holder according to claim 11, wherein the stops are arranged at the drain end of the insertion compartment.

13. Vehicle washing facility with a cleaning lance and a holder for the cleaning lance, wherein the holder is constructed according to claim 1.

14. Vehicle washing facility according to claim 13, wherein the fluid drain is connected to a fluid reprocessing system of the vehicle washing facility.

15. Vehicle washing facility according to claim 13, wherein the holder is part of a closed fluid circuit of the vehicle washing facility.
